(19) United States
(12) Patent Application Publication
(10) Pub. No.: US 2009/0085457 A1
(43) Pub. Date: Apr. 2, 2009

(54) FIELD EMISSION CATHODE AND METHOD FOR MANUFACTURING THE SAME

(75) Inventors: Hong-Ming LIN, Taipei (TW); Cheng-Han Chen, Taipei (TW); Yu-Hang Peng, Taipei (TW); Jyi-Tsong Lo, Taipei (TW); Tsuey-May Yin, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: Tatung Company, Taipei (TW)

(21) Appl. No.: 12/177,224

(22) Filed: Jul. 22, 2008

(30) Foreign Application Priority Data
Jul. 23, 2007 (TW) 096126739

(51) Int. Cl. H01J 9/02

(52) U.S. Cl. 313/310; 445/51

(57) ABSTRACT

A field emission cathode and a method for manufacturing the same are disclosed. In the present invention, the carbon nanotube is coated with an amorphous coating material so that the above-mentioned field emission cathode resists oxidization in a high electrical field and the structure thereof can be protected. Additionally, the field emission cathode can exhibit field emission performance in a low electrical field, and generate stable current as the electrical field increases so that the efficiency and stability of the field emission current can be enhanced.

### BACKGROUND OF THE INVENTION

1. Field of the Invention

The present invention relates to a field emission cathode and a method for manufacturing the same and, more particularly, to a field emission cathode and a method for manufacturing the same, which are suitable for a field emission display device.

2. Description of Related Art

Carbon nanotubes have become a material of special interest since experimental discovery by NEC Company in Japan in 1991. That is, because the carbon nanotube has various outstanding properties, such as electronic characteristics of metals or semiconductors, hollow shapes with extremely small tip curvature radius, high chemical stability, great mechanical strength, excellent storability referring to gas and so forth in accordance with various coiling of graphite layers and different tube diameters, it is particularly suitable for diverse applications.

The carbon nanotube is a graphite tube having a nano-diameter and a high ratio of length to diameter. The inner diameter of the carbon nanotube can be in the range of from 0.4 to several ten nanometers; the outer diameter thereof can be in the range of from 1 to several hundred nanometers, and the length thereof can be in the range of from several micrometers to several ten micrometers. The structure of the nanotube can be a hollow tube structure formed by coiling a single or multiple graphite layers. When the carbon nanotube is applied in a cathode structure of a field emission display device, it can induce the cathode to generate a great current density at a low applied voltage because of its high ratio of length to diameter and its great chemical stability. Accordingly, the carbon nanotube has become the most preferred material for emitters in a cathode of a field emission display device.

However, the temperature of the carbon nanotube can increase resulting from the applied electrical field causing an ohmic heating effect during operation of the field emission display device. Subsequently, the carbon nanotube is reacted with the residue gas resulting in oxidation thereof so that the lifespan of the field emission display device is shortened and the current stability is influenced.

### SUMMARY OF THE INVENTION

The object of the present invention is to provide a field emission cathode and a method for manufacturing the same so that the structure of the field emission cathode can be protected in a high electrical field.

Another object of the present invention is to provide a field emission cathode and a method for manufacturing the same so that the efficiency and stability of the field emission current can be enhanced.

To achieve the object, the present invention provides a field emission cathode which comprises a carbon nanotube and an amorphous coating material. The amorphous coating material is applied on a surface of the carbon nanotube.

To achieve the object, the present invention provides a method for manufacturing a field emission, which comprises the following steps: thoroughly mixing a precursor and a carbon nanotube to form a first mixture; and heating the first mixture so as to apply an amorphous coating material on a surface of the carbon nanotube.

The above-mentioned carbon nanotube can be any structure, but preferably is a multi-walled carbon nanotube. The above-mentioned amorphous coating material can be made of any material. Preferably, the amorphous coating material is made of silicon dioxide. More preferably, the amorphous coating material is a silicon dioxide thin film of an amorphous structure.

The above-mentioned amorphous coating material can be produced from the precursor and then adhered on the surface of the carbon nanotube. The precursor can be any material suitable for a sol-gel method, but preferably is tetraethoxysilane.

Before the precursor and the carbon nanotube are well mixed, the carbon nanotube can be washed for removing catalysts and impurities thereof by using an acid solution. Additionally, the carbon nanotube can be well dispersed in a solution by ultrasonication so as to be well-mixed with the precursor.

The above-mentioned precursor and carbon nanotube can be mixed in any ratio. Preferably, the ratio by weight of the precursor to the carbon nanotube is in the range of 10 to 30. After the precursor and the carbon nanotube are well mixed, the first mixture can be stirred until becoming dry. Preferably, the first mixture is stirred at room temperature until powders thereof are obtained. Then, the first mixture can be heated in an argon atmosphere until the temperature is in the range of from 700° C. to 900° C. Therefore, the amorphous coating material can be produced from the precursor and formed on the surface of the carbon nanotube, and the thickness thereof is preferably in the range of from 1 to 20 nanometers, and more preferably is in the range of from 5 to 10 nanometers.

Then, the carbon nanotube, which is coated with the amorphous coating material, is mixed with a conductive paste to form a second mixture, and the second mixture is applied on a surface of a conductive substrate. The conductive substrate is heated to remove impurities such as a solvent and to enhance the adhesion between the amorphous coating material and the carbon nanotube. The conductive substrate is not limited to, but preferably is conductive glass such as ITO. The conductive paste can be made of any material, but preferably is silver paste.

Because the carbon nanotube is coated with the foregoing amorphous coating material, the aforementioned field emission cathode is resistant to oxidation in a high electrical field and the structure thereof can be protected. Furthermore, the field emission cathode can demonstrate field emission performance, and generate stable current as the electrical field increases so as to enhance the efficiency and stability of the field emission current.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the structure of the field emission cathode in the first preferred example of the present invention;

FIG. 2 is a flowchart of the method for manufacturing the field emission cathode of the first preferred example in the present invention;

FIG. 3 shows the field emission cathode in the second preferred example of the present invention;

FIG. 4 shows the field emission cathode in the third preferred example of the present invention;

FIG. 5 is I-V (current density-applied voltage) diagram of a conventional carbon nanotube and the field emission cathodes in the second and third preferred examples of the present invention; and

FIG. 6 is time-current diagram of a conventional carbon nanotube and the field emission cathodes in the second and third preferred examples of the present invention in the same electrical field.

### DETAILED DESCRIPTION OF THE PREFERRED EMBODIMENT

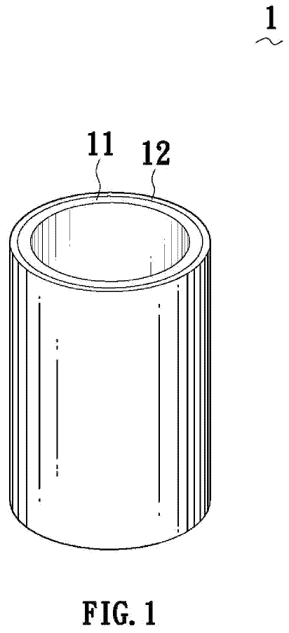

With reference to FIG. 1, there is shown a perspective view of the structure of a field emission cathode in the first preferred example of the present invention.

As shown in FIG. 1, the field emission cathode 1 includes a carbon nanotube 11 and an amorphous coating material 12. In the present example, the carbon nanotube 11 is a multi-walled carbon nanotube which is a hollow tube structure. The amorphous coating material 12 is attached on an outer surface of the carbon nanotube 11. The amorphous coating material 12 mentioned above is a silicon dioxide thin film of an amorphous structure, which can protect the carbon nanotube from oxidation in a high electrical field so that the carbon nanotube can generate current stably.

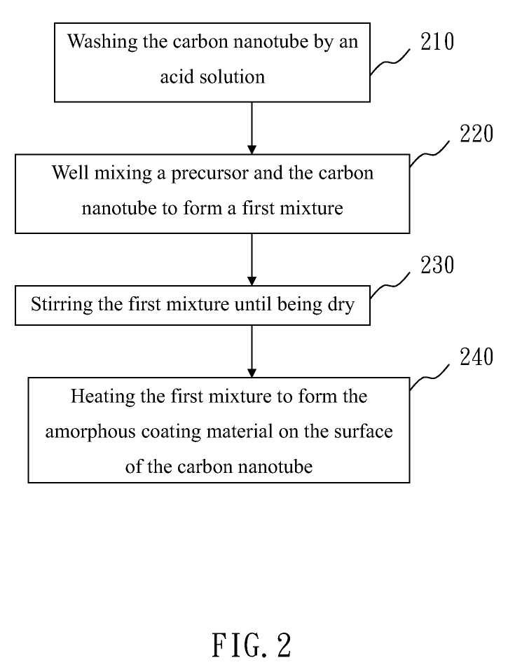

Furthermore, with reference to FIG. 2, there is a flowchart of a method for manufacturing the field emission cathode 1 of the present example.

First, the carbon nanotube 11 is washed by using an acid solution (step 210) to remove catalysts and impurities included in the carbon nanotube 11. In the present example, the acid solution is nitric acid. The ratio of the acid solution to the carbon nanotube is 2:1. The carbon nanotube is mixed with the acid solution and heated at 110° C. for 6 hours.

Secondly, the washed carbon nanotube 11 is well mixed with a precursor to form a first mixture (step 220). In the present example, 0.05 g of the washed carbon nanotube 11 is added to 300 ml of ethanol solvent, and dispersed in the solvent uniformly by ultrasonication for 10 minutes. A solution, in which the ratio by weight of the precursor:deionized water:ethanol solvent is 2:1:4, is prepared, and then mixed with the ultrasonicated and well-dispersed carbon nanotube 11. Herein, the precursor is tetraethoxysilane suitable for a sol-gel method, but other ingredients suitable for the sol-gel method can be used as precursors in other examples. Additionally, in accordance with the different ratio by weight of the precursor, various thicknesses of the amorphous coating material 12 can be produced. In other words, the ratio by weight of the precursor is not limited to a specific ratio, and that is determined in accordance with the desired thickness of the amorphous coating material 12. In the present example, the ratio by weight of the precursor to the carbon nanotube 11 can be in the range of from 10 to 30.

Subsequently, the first mixture containing the well-mixed carbon nanotube 11 and precursor is stirred until becoming dry (step 230). In the present example, the first mixture is stirred magnetically until becoming dry and forming powders.

Then, the dried first mixture is heated to produce the amorphous coating material 12 (step 240). In the present invention, the amorphous coating material 12 is produced by heating the dried powders placed in an argon atmosphere until the temperature reaches 800° C. for 1.5 hours so that the siloxane group of the precursor is bonded with the functional groups on the surface of the carbon nanotube 11. However, the temperature is not limited to the abovementioned, and it can be in the range of from 700° C. to 900° C.

Moreover, the carbon nanotube 11 with the amorphous coating material 12 formed thereon in the step 240 is mixed with a conductive paste to form a second mixture, and the second mixture is applied on a surface of a conductive substrate. In the present invention, the foregoing conductive paste is silver paste, and the conductive substrate described above is ITO. The ratio by weight of the conductive paste to the carbon nanotube 11 is 7:1. In addition, the carbon nanotube 11 is mixed with the silver paste by a deforming mixer to form the second mixture, and the second mixture is applied uniformly on the conductive substrate by a spin coater or a screen printer. However, other apparatuses can be used to achieve the same purpose in other examples.

Finally, the coated conductive substrate is heated to remove residues such as a solvent so that the carbon nanotube 11 and the silver paste are densely and firmly attached on the surface of the conductive substrate.

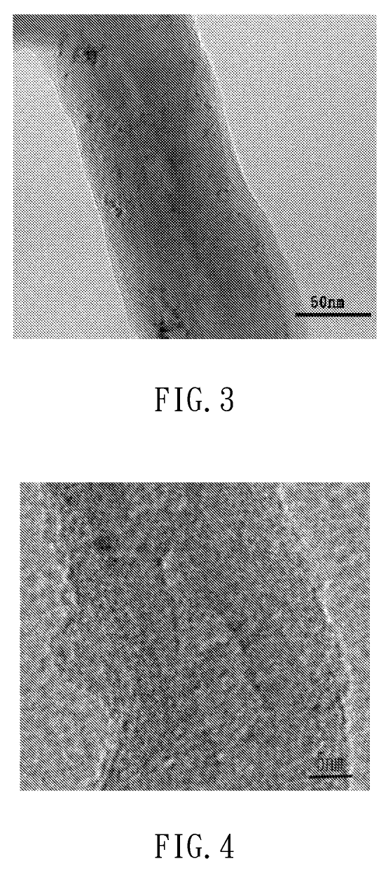

With reference to FIGS. 3 and 4, there are shown the field emission cathodes respectively in the second and third preferred examples of the present invention. The field emission cathodes in the second and third examples of the present invention are manufactured in a similar manner as the first example, but the only one difference therebetween is the ratio by weight of the precursor to the carbon nanotube so that the thickness of the amorphous coating material is different to that in the first example. In FIG. 3, the thickness of the amorphous coating material on the outer surface of the carbon nanotube is 10 nanometers. In FIG. 4, the thickness of the amorphous coating material is 5 nanometers.

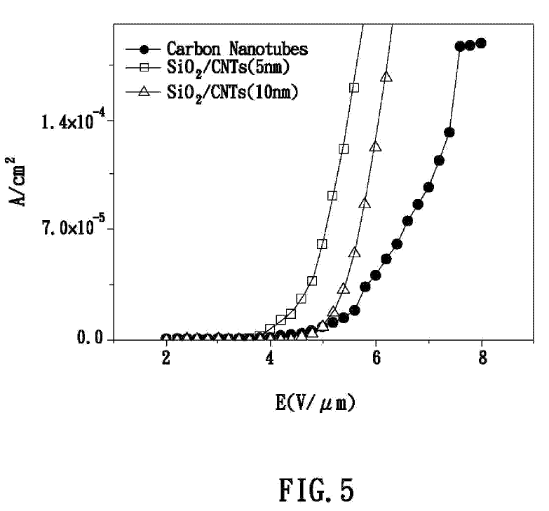

With reference to FIG. 5, there is shown an I-V (current density-applied voltage) diagram of conventional carbon nanotube and the field emission cathodes in the second and third preferred example of the present invention. As shown in FIG. 5, comparing the curve of the conventional carbon nanotube (black dot) with that of the second example (hollow triangle) or that of the third example (hollow square), the conventional carbon nanotube needs an enhanced electrical field to generate currents. In other words, the field emission cathodes, which are made of carbon nanotube with the amorphous coating material formed thereon, of the present invention can generate field emission current in a lower electrical field than the conventional carbon nanotube. Therefore, the field emission efficiency of the field emission cathodes in the present invention is enhanced.

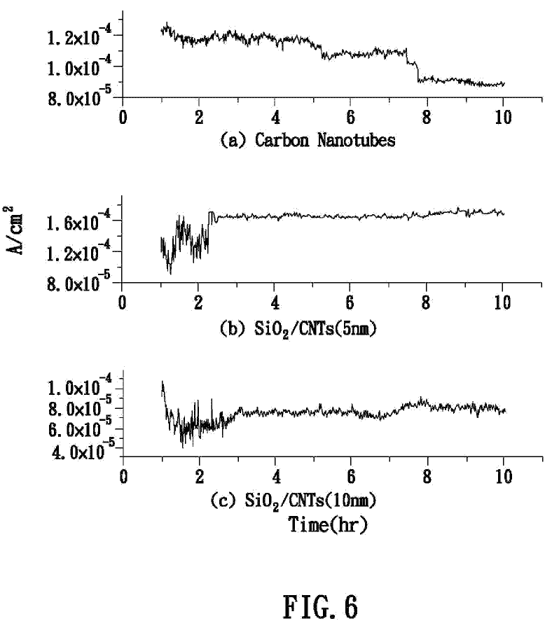

Furthermore, with reference to FIG. 6, there is shown a time-current diagram, at an electrical field of 7 V/μm, of the conventional carbon nanotube and the field emission cathodes in the second and third examples of the present invention. As shown in FIG. 6, compared with the field emission current of the conventional carbon nanotube, those of the field emission cathodes in the second and third preferred examples of the present invention demonstrate stably towards a value as time increases.

Hence, in accordance with the abovementioned, in the field emission cathodes of the present invention, the amorphous coating material formed and attached on a surface of the carbon nanotube can protect the carbon nanotube from oxidation and destruction in a high electrical field and improve the efficiency and current of the field emission.

Although the present invention has been explained in relation to its preferred embodiment, it is to be understood that many other possible modifications and variations can be made without departing from the scope of the invention as hereinafter claimed.

What is claimed is:

1. A field emission cathode comprising:
a carbon nanotube; and
an amorphous coating material formed and attached on a surface of the carbon nanotube.

2. The field emission cathode as claimed in claim 1, wherein the carbon nanotube has a hollow tube structure.

3. The field emission cathode as claimed in claim 2, wherein the carbon nanotube is a multi-walled carbon nanotube.

4. The field emission cathode as claimed in claim 1, wherein the amorphous coating material is a thin film.

5. The field emission cathode as claimed in claim 1, wherein the amorphous coating material is silicon dioxide.

6. The field emission cathode as claimed in claim 1, wherein the amorphous coating material is formed and attached on the surface of the carbon nanotube by heating a precursor.

7. The field emission cathode as claimed in claim 6, wherein the precursor is tetraethoxysilane.

8. The field emission cathode as claimed in claim 6, wherein the ratio by weight of the precursor to the carbon nanotube is in the range of from 10 to 30.

9. The field emission cathode as claimed in claim 1, wherein the thickness of the amorphous coating material is in the range of from 1 to 20 nanometers.

10. The field emission cathode as claimed in claim 1, wherein the thickness of the amorphous coating material is in the range of from 5 to 10 nanometers.

11. A method for manufacturing a field emission cathode comprising:
thoroughly mixing a precursor and a carbon nanotube to form a first mixture; and
heating the first mixture so as to produce an amorphous coating material on a surface of the carbon nanotube.

12. The method as claimed in claim 11, further comprising washing the carbon nanotube by an acid solution.

13. The method as claimed in claim 11, wherein the carbon nanotube is well mixed with the precursor by ultrasonication.

14. The method as claimed in claim 11, wherein the first mixture is stirred until becoming dry.

15. The method as claimed in claim 11, wherein the first mixture is heated in an argon atmosphere until the temperature is in the range of from 700° C. to 900° C.

16. The method as claimed in claim 11, wherein the carbon nanotube is a multi-walled carbon nanotube.

17. The method as claimed in claim 11, wherein the precursor is tetraethoxysilane.

18. The method as claimed in claim 11, wherein the amorphous coating material is silicon dioxide.

19. The method as claimed in claim 11, further comprising mixing a conductive paste and the carbon nanotube coated with the amorphous coating material to form a second mixture and applying the second mixture to a conductive substrate.

20. The method as claimed in claim 19, further comprising heating the conductive substrate.
